(19) United States
(12) Patent Application Publication
(10) Pub. No.: US 2017/0151555 A1
(43) Pub. Date: Jun. 1, 2017

(54) METHOD FOR PREPARING SHAPED POROUS INORGANIC MATERIALS, BY REACTIVE EXTRUSION

(71) Applicant: IFP Energies nouvelles, Rueil-Malmaison (FR)

(72) Inventors: Malika BOUALLEG, Villeurbanne (FR); Delphine BAZER-BACHI, Irigny (FR); Alexandra CHAUMONNOT, Lyon (FR); Laetitia ASSIE, Thil (FR)

(73) Assignee: IFP Energies nouvelles, Rueil-Malmaison (FR)

(21) Appl. No.: 15/321,574

(22) PCT Filed: Jun. 30, 2015
(86) PCT No.: PCT/EP2015/064884

§ 371 Date: Dec. 22, 2016

(30) Foreign Application Priority Data
Jun. 30, 2014 (FR) 1456144

(51) Int. Cl. B01J 37/00; B01J 27/16; B01J 21/12; B29C 47/40; B01J 37/28; B01J 37/06; B01J 37/08; B29C 47/00; B01J 21/04; B01J 37/04

(52) U.S. Cl. CPC B01J 37/0009; B01J 21/04; B01J 27/16; B01J 21/12; B01J 37/04; B01J 37/28; B01J 37/06; B01J 37/08; B29C 47/0009; B29C 47/402

(57) ABSTRACT

A method for preparing a porous inorganic material by at least:
a) reaction of a mixture of one precursor of the oxide of a metal X in solution and a precursor of the oxide of a metal Y at a temperature of between 30 and 70° C., X and Y being, independently aluminum, cobalt, indium, molybdenum, nickel, silicon, titanium, zirconium, zinc, iron, copper, manganese, gallium, germanium, phosphorus, boron, vanadium, tin, lead, hafnium, niobium, yttrium, cerium, gadolinium, tantalum, tungsten, antimony, europium or neodymium;
b) mixing of the mixture obtained at the end of a) at a temperature of between 80 and 150° C., the mixing period being adjusted so as to obtain a paste that exhibits a fire loss of between 20% by weight and 90% by weight;
c) shaping of the porous inorganic material;
   a) to c) being performed within an extruder.

### TECHNICAL FIELD OF THE INVENTION

This invention relates to the field of shaped porous inorganic materials, particularly oxide-based materials that exhibit a particularly suited porosity for catalytic applications, in particular in the field of refining and petrochemistry. It relates more specifically to the preparation of these materials that are obtained by using the technique of synthesis and of shaping said to be “by reactive extrusion.”

### PRIOR ART

Generally, an extrusion method makes possible the shaping of solids made in the form of paste by a suitable mixing of powder at a given temperature (in the presence of possible additives and/or liquids), via a forced flow of the material through an opening of finite dimension (die). In the specific case of reactive extrusion, the extruder can also act as a chemical reactor, seat of reactions between molecular or macromolecular reagents leading to the formation at the outlet of the die of a solid object or material. This characteristic is particularly used in the field of polymers. The most appropriate tool that is well known to a person skilled in the art to operate in reactive mode is the twin-screw extruder, the latter consisting, as its name indicates, of two screws that can be counter-rotating or co-rotating that turn inside a cylindrical extruder barrel that is temperature-regulated by heating and/or cooling means.

Reactive extrusion is therefore a method that combines, in a continuous operating mode, both steps of “synthesis” and “shaping” of solids. Such a method is widely used in the field of food processing and in the industry of polymers. In this latter case, the extruder, in addition to shaping the polymer objects, can be considered as a polymerization reactor. More specifically, the steps involved are the following: 1) introduction of monomer-type reagents, 2) performing of polymerization reactions at the beginning of mixing, and 3) shaping of the polymer thus formed at the outlet of the extruder. Such a method has thus made it possible to obtain different families of polymers (polyamides: B. Lee, J. White, Intern Polym Proc., 2001, 16, 172; polyurethanes: M. Semsarzadeh, A. Navarchian, J. Morshedian, Advances in Polymer Technology, 2004, 23, 239; polystyrenes: W. Michaeli, H. Hocker, U. Berghaus, W. Frings, Journal of Applied Polymer Science, 1993, 48, 871, etc.), of copolymers (B. Kim, J. White, Journal of Applied Polymer Science, 2003, 88, 1429), as well as the chemical modification of the latter by grafting reactions, mixtures of polymers or post-polymerization (Cassagnau, V. Bounor-Legaré, F. Fenouillot, Intern. Polymer Processing, 2007, 3, 217). The development of nanocomposite materials has also been studied, the latter being derived from the assembly of at least two immiscible materials, of which one of the components at a minimum is of nanometric size. More recently, by association of “sol-gel” chemistry (hydrolysis-condensation reactions of inorganic precursors) and of a polymer matrix, polymer/inorganic material nanocomposites have also been obtained by reactive extrusion, such as, for example, polypropylene/titanium dioxide systems (W. Bahloul, O. Oddes, V. Bounor-Legaré, F. Melis, P. Cassagnau, B. Vergnes, AICHE Journal, 2011, 57, 2174), EVA (ethylene vinyl acetate)/silica (B.-H. Phe, V. Bounor-Legaré, L. David, A. Michel, Journal of Sol-Gel Science and Technology, 2004, 31, 47), polypropylene/aluminosilicate (E. Rondeau, UCBL Thesis, 2005). It can be considered to vary the form factor of the inorganic phase created by controlling the progress of the sol-gel reactions considered (Blanckaert J et al., Journal of Sol-Gel Science and Technology, 2012, 63, 85).

Twin-screw-type extruders are also used as mixing-extrusion tools for the production of substrates of catalysts such as alumina-based substrates, which do not fall within the reactive extrusion but rather within continuous-tool standard shaping operations.

The main advantage of reactive extrusion is that it makes it possible to perform the synthesis and the shaping of solids in a single step. The associated tool can operate at high temperature, with considerable thermal gradients, as well as under high pressures. Highly viscous media, in the total or almost total absence of solvent(s), can be extruded. Thus, this method is known to be more economical but also more respectful of the environment than certain other methods of synthesis or shaping. By contrast, the conveyance and mixing capability of the tool can be limited or degraded when the reagents or the products involved exhibit a viscosity that is too low.

Furthermore, the transfer in the case of the synthesis and shaping of porous inorganic materials is not easy because it necessitates working from at least one precursor in liquid form (with a viscosity close to that of water), not very suitable for using an extruder, the conveying and the mixing being made difficult by the low viscosity.

The traditional methods for synthesis of porous inorganic materials comprise a synthesis step that comprises a precipitation or gelling in solution, followed by a filtering step at the end of which the fire loss is lowered relative to the synthesis step. The filtered material is then put back in suspension, which leads to an increase of the fire loss, for the purpose of its atomization. The particles obtained at the end of the atomization have a very slight fire loss, which must be increased by addition of additives or of solvents to enable the step for shaping (extrusion, granulation or the like).

The applicant has discovered a method of preparation and operating conditions that make it possible to reduce drastically the synthesis time of a porous inorganic material, and that reduce the addition of external solvents by minimizing the variations of fire loss throughout the synthesis process until obtaining the shaped porous inorganic material.

### OBJECT AND ADVANTAGE OF THE INVENTION

The invention relates to a method for preparing a shaped porous inorganic material by reactive extrusion.

The applicant discovered that it was possible to apply the reactive extrusion method to the synthesis and to the shaping of porous inorganic material, in a continuous single step. The idea of this invention consists in using the extruder as a chemical reactor to perform the hydrolysis and condensation reactions involved during the nucleation/growth steps during the synthesis of oxide-based porous inorganic materials. Surprisingly, it has thus been possible to produce, via this method, shaped objects from mixtures of greatly varying viscosities.

The innovative use of this technology in this field has made it possible in particular to have access to materials that have advantageous properties (textural, mechanical, acid-basic, etc.) in a continuous single operation in contrast with the more traditionally used technologies and that decouple the different operations that lead to the production of the solid (synthesis, washing, drying, shaping). In addition, a method that makes it possible in a single step to transform a mixture containing at least one precursor in liquid form, i.e., in solution or in colloidal suspension, the two systems being indiscriminately called “solution” in the disclosure below, into shaped oxide-based porous inorganic material represents a considerable gain in terms of cost compared with a traditional shaping and synthesis protocol consisting of a large number of steps. Furthermore, this technology can easily be extrapolated on a large scale. The results obtained on a laboratory scale on the enhanced method according to the invention can be used directly on an industrial scale.

The use of an extruder according to the method of the invention makes it possible to perform all of the unit steps in a single scalable tool.

### DETAILED DESCRIPTION OF THE INVENTION

The invention relates to a method for preparing a porous inorganic material having at least the following steps:
a) reaction of a mixture comprising at least one precursor of the oxide of a metal X in solution in a solvent and a precursor of the oxide of a metal Y at a temperature of between 30 and 70° C., X and Y being, independently, selected from the group consisting of aluminum, cobalt, indium, molybdenum, nickel, silicon, titanium, zirconium, zinc, iron, copper, manganese, gallium, germanium, phosphorus, boron, vanadium, tin, lead, hafnium, niobium, yttrium, cerium, gadolinium, tantalum, tungsten, antimony, europium and neodymium;
b) mixing of the mixture obtained at the end of step a) at a temperature of between 80 and 150° C., the mixing period being adjusted so as to obtain a paste that exhibits a fire loss of between 20% by weight and 90% by weight at the end of this step;
c) shaping of the porous inorganic material;
   steps a) to c) being performed within an extruder.

### Reaction Step a)

According to the invention, the preparation method comprises a step a) for reaction of a mixture comprising at least one precursor of the oxide of a metal X in solution in a solvent and a precursor of the oxide of a metal Y, at a temperature of between 30 and 70° C.

X and Y are selected, independently, from the group consisting of aluminum, cobalt, indium, molybdenum, nickel, silicon, titanium, zirconium, zinc, iron, copper, manganese, gallium, germanium, phosphorus, boron, vanadium, tin, lead, hafnium, niobium, yttrium, cerium, gadolinium, tantalum, tungsten, antimony, europium and neodymium.

Preferably, the element X is selected from the group consisting of aluminum, silicon, titanium and zirconium, and in a very preferred manner from the group consisting of aluminum and silicon.

Preferably, the element Y is selected from the group consisting of aluminum, silicon, titanium, boron, phosphorus and zirconium, and in a very preferred manner from the group consisting of aluminum, phosphorus, and silicon.

The precursor of the oxide of the metal X can be any compound comprising the element X and that can release this element in solution, for example in aqueous, aqueous-organic or organic solution, preferably in aqueous solution, in reactive form. In the case where X is selected from the group consisting of silicon, aluminum, titanium and zirconium, the precursor of the element X is advantageously an inorganic salt of said element X of formula XZn (n=3 or 4), Z being a halogen, the NO₃ grouping or a perchlorate. Preferably, Z is chlorine. The precursor of the element X being considered can also be an organometallic precursor of formula X(OR)n where R=ethyl, isopropyl, n-butyl, s-butyl, t-butyl, etc., or a chelated precursor such as X(C₅H₈O₂) with n=3 or 4. The precursor of the element X being considered can also be an oxide or a hydroxide of the element X. As a function of the nature of the element X, the precursor of the element X being considered that is used can also have the form XOZ₂, Z being a monovalent anion such as a halogen or the NO₃ grouping. In a preferred manner, said element X is selected from the group consisting of silicon, aluminum, titanium and zirconium.

In the very preferred case where X is the element silicon, said silicic precursor is then obtained from any silica source and advantageously from a sodium silicate precursor of formula Na₂SiO₃, from a chlorinated precursor of formula SiCl₄, from an organometallic precursor of formula Si(OR)₄ where R═H, methyl, ethyl, or from a chloralkoxide precursor of formula Si(OR)₄-xClx where R═H, methyl, ethyl, x being between 0 and 4. The silicic precursor can also advantageously be an organometallic precursor of formula Si(OR)₄-xR′x where R═H, methyl, ethyl, and R′ is an alkyl chain or an alkyl chain that is functionalized by, for example, a thiol, amino, diketone or sulfonic acid grouping, x being between 0 and 4. The precursor of the element X, in its oxide or hydroxide form, can also be powdered solid silica, silicic acid, colloidal silica, dissolved silica, etc.

In the very preferred case where X is the element aluminum, the aluminum precursor is advantageously an inorganic salt of aluminum of formula AlZ₃, Z being a halogen, a nitrate or a hydroxide. Preferably, Z is chlorine. The aluminum precursor can also be an aluminum sulfate of formula Al₂(SO₄)₃. The aluminum precursor can also be an organometallic precursor of formula Al(OR)₃ where R═ethyl, isopropyl, n-butyl, s-butyl (Al(OₛC₄H₉)₃) or t-butyl or a chelated precursor such as aluminum acetylacetonate (Al(C₅H₈O₂)₃). Preferably, R is s-butyl. The aluminum precursor can also be sodium aluminate or potassium aluminate or ammonium aluminate or alumina itself in one of its crystalline phases known to a person skilled in the art (alpha, delta, theta, gamma), preferably in hydrated form or in a form that can be hydrated.

Mixtures of the precursors cited above can also be used. In particular, some or all of the aluminum and silicic precursors can optionally be added in the form of a single compound comprising both aluminum atoms and silicon atoms, for example an amorphous silica-alumina.

Said solvent is advantageously water, ethanol, propan-1-ol, propan-2-ol, 2-methylpropan-1-ol, 2-methyl-propan-2-ol, 2,2-dimethylpropanol, butanol, 2-butanol, 2-methylbutan-2-ol, 3-methylbutan-2-ol, pentanol, 2-methylbutan-1-ol, 3-methylbutan-1-ol, pentan-2-ol, pentan-3-ol, by itself or in a mixture, very advantageously water or ethanol by itself or in a mixture. In a very preferred manner, said solvent is water.

The precursor of the oxide of a metal Y can advantageously be added to the mixture of step a) in solution in said solvent or in powder form.

In a preferred manner, the mixture reacting during step a) does not contain any surfactant that generates mesoporosity.

Surfactant that generates mesoporosity is defined as an ionic or non-ionic surfactant or a mixture of the two. The ionic surfactants that generate mesoporosity can be cationic and anionic surfactants. For example, the cationic surfactants can be the phosphonium or ammonium ions and very preferably the quaternary ammonium salts such as cetyltrimethylammonium bromide (CTAB). For example, the anionic surfactants can be sulfates, such as, for example, sodium dodecyl sulfate (SDS). For example, the non-ionic surfactants can be any copolymer having at least two parts with different polarities that impart to them properties of amphiphilic macromolecules. These copolymers can have at least one block that is part of the non-exhaustive list of the following families of polymers: the fluorinated polymers (—[CH2-CH2-CH2-CH2-O—CO—R1- with R1=C4F9, C8F17, etc.), the biological polymers such as the amino polyacids (polylysine, alginates, etc.), the dendrimers, the polymers consisting of chains of poly(alkylene oxide). Any other copolymer having an amphiphilic nature known to a person skilled in the art can be like poly(styrene-b-acrylamide), for example (S. Förster, M. Antionnetti, Adv. Mater., 1998, 10, 195; S. Förster, T. Plantenberg, Angew. Chem. Int. Ed., 2002, 41, 688; H. Cölfen, Macromol. Rapid Commun., 2001, 22, 219).

During the reaction step a), reactions of nucleation, growth, agglomeration and aggregation of said precursors take place. The pH and the temperature are regulated at target values. The pH is maintained by regulating the ratio of the flow rates of the various precursors.

In the preferred case of synthesis of a boehmite-type porous inorganic material, the mixture reacting in step a) comprises at least one basic precursor selected from among sodium aluminate, potassium aluminate, ammonia, sodium hydroxide and potassium hydroxide, and at least one acid precursor selected from among aluminum sulfate, aluminum chloride, aluminum nitrate, sulfuric acid, hydrochloric acid and nitric acid, at least one of the basic or acid precursors comprising aluminum, the relative flow rate of the acid and basic precursors being selected so as to obtain a pH of the reaction medium of between 7 and 10.5.

In a particular arrangement, said precursors are mixed prior to step a), for example within a static mixer, at a temperature of between 30 and 70° C. This mixing prior to step a) makes it possible, by initiating the synthesis reaction, to control more finely the textural properties of the porous inorganic material obtained by the method according to the invention.

The precursors are introduced into the extruder by a feeding means that can be a feeding hopper for the powders, and/or a pump, a syringe pump and optionally a mixing device (such as an internal mixer, T-mixer, or any type of premixer known to a person skilled in the art, such as, for example, the Y-mixer, the Rotor Stator, the Hartridge-Roughton) for liquids, said means being placed upstream from the extruder. This feeding means is called the main feeding means.

### Mixing Step b)

According to the invention, the mixture obtained at the end of step a) is mixed at a temperature of between 80 and 150° C., the duration of the mixing being adjusted so as to obtain a paste exhibiting a fire loss at the end of step b) of between 20 and 90%, preferably between 20 and 75%, preferably between 20% and 65%, in a preferred manner between 40% and 65%. The fire loss is calculated by the difference in mass of the sample before and after calcination at 1000° C. for 3 hours like the ratio of the difference between the initial mass and the final mass to the initial mass. The percentage is therefore a percentage by weight.

This step makes it possible to eliminate a portion of the solvent present in the mixture obtained at the end of step a) so as to reduce the fire loss of the mixture. The operating temperature of said step b) makes it possible to evaporate the solvent. It is also possible to adapt the screw profile in the module or modules of the extruder in which said step b) is carried out so as to press the mixture, and thus to extract a portion of the solvent.

As a function of the mixture obtained at the end of said step a), a person skilled in the art adjusts the length and/or the profile of the screw of the modules in which said step b) is carried out to ensure a sufficient dwell time to attain the desired fire loss. Thus, the speed of advance will be reduced and/or the length of the module or modules in which said step b) is carried out will be increased if the fire loss is too great at the outlet of the last module in which step b) is carried out and vice versa.

### Washing Step b1)

In the case where the precursors are salts, a washing step b1) is performed within the extruder so as to eliminate undesirable radicals for the catalytic substrate intended. A solvent is incorporated into the mixture obtained at the end of step b) by mixing. Said solvent is advantageously water, an aqueous solution of ammonium nitrate, ethanol, propan-1-ol, propan-2-ol, 2-methylpropan-1-ol, 2-methyl-propan-2-ol, 2,2-dimethylpropanol, butanol, 2-butanol, 2-methylbutan-2-ol, 3-methylbutan-2-ol, pentanol, 2-methylbutan-1-ol, 3-methylbutan-1-ol, pentan-2-ol, pentan-3-ol.

### Mixing Step b2)

When a washing step b1) is carried out, a step of mixing within the extruder at a temperature of between 80 and 150° C. is then carried out, the duration of the mixing being adjusted so as to obtain a paste having a fire loss at the end of step b2) of between 20 and 90%, preferably between 20 and 75%, preferably between 20% and 65%, in a preferred manner between 40% and 65%.

This step makes it possible to eliminate a portion of the solvent present in the mixture obtained at the end of step b1) in such a way as to reduce the fire loss of the mixture. The operating temperature of said step b2) makes it possible to evaporate the solvent. This step is similar in its functioning and its operation to the mixing step b). The adjustment of the operating parameters is applied therefore mutatis mutandis.

### Additivation Step b3)

As a function of the desired final formulation for the porous inorganic solid produced by the method according to the invention, an additivation step is advantageously initiated, within the extruder, in which step one or more formulation additives that are incorporated into the mixture by mixing are added to the mixture obtained at the end of step b), or obtained at the end of step b2) if one or more washing cycles have been necessary.

Said formulation additives can be solid, liquid or gaseous, and preferably solid or liquid. “Formulation additive” refers to the products that are well-known to a person skilled in the art and that make it possible to improve the performance of the system, such as adjuvants to facilitate the extrusion or to optimize the rheology of the system, peptizing agents making it possible to obtain a better dispersion of the binder or of the feedstocks, agents making it possible to improve the mechanical characteristics of the material (feedstocks, binders, compatibilizing agents), to adjust the porous properties (such as pore-forming agents, dispersing agents, coagulants), to optimize the surface characteristics, the physico-chemical properties, the chemical composition, etc. These additives can have a mineral or organic composition. In the case of organic compounds, they will be able to be advantageously eliminated during step d).

Said formulation additives can also comprise metal particles. Metal particles are defined as particles of a size of at most 300 nm, preferably of at most 50 nm, and in an even more preferred way of at most 3 nm. The size of said metal particles is advantageously measured by transmission electron microscopy (TEM), when the former is greater than 1 nm. The absence of detection of metal particles by TEM therefore means that said metal particles have a size smaller than 1 nm.

Said metal particles comprise at least one metal belonging to the family of transition metals corresponding to columns 3 to 12 of the periodic table according to the classification of the IUPAC and/or to the family of metals of the lanthanide and actinide rare earths, preferably belonging to the group consisting of Au, Pd, Pt, Ni, Co, Cu, Ag, Rh, Ru, Jr, Fe, Ti, Zr, Nb, Ta, Mo, W, Fe, Y, La, Cr, Ce, Eu, Nd, Gd, Sn, In by itself or in a mixture, in a very preferred way belonging to the group Au, Pd, Pt, Ni, Co, Rh, Ti, Zr, Mo, W, Sn, In by itself or in a mixture, in reduced forms, oxide (including the polymetal oxide form), chalcogenide and polyoxometalate (isopolyanion and heteropolyanion (HPA)). The isopolyanions and the heteropolyanions used are perfectly described in the work Heteropoly and Isopoly Oxometalates, Pope, Ed Springer-Verlag, 1983. In particular, said HPAs are HPAs of the following types: Anderson (Nature, 1937, 150, 850), Keggin (A. Griboval, P. Blanchard, E. Payen, M. Fournier, J. L. Dubois, Chem. Lett., 1997, 12, 1259; C. Dablemont et al., Chemistry, 2006, 12, 36, 9150; L. G. A. van de Water et al., J. Phys. Chem. B, 2005, 109, 14513) and Strandberg (W-C. Cheng et al., J. Catal., 1988, 109, 163).

Said metal particles can advantageously be added in said step b3) in their reduced form, oxide, chalcogenide or polyoxometalate.

Among the organic additives, it will advantageously be possible to use polyethylene glycols, monocarboxylic aliphatic acids, alkylated aromatic compounds, sulfonic acid salts, fatty acids, polyvinylpyrrolidone, polyvinyl alcohol, methylcellulose, cellulose derivatives, hydroxyethylated cellulose-type derivatives, carboxymethyl cellulose, polyacrylates, polymethacrylates, polyisobutene, polytetrahydrofuran, starch, polysaccharide-type polymers (such as xanthan gum), alginates, scleroglucan, lignosulphonates and galactomannan derivatives, by itself or in a mixture.

Among the mineral additives, it is possible to use, for example, oxides or oxide precursors that are well known to a person skilled in the art: boehmite, alumina, silica, titanium oxide, zirconium oxide, lanthanum oxide, cerium oxide, magnesia, zincite, iron oxide, copper oxide, mixed oxides such as aluminosilicates, spinels, perovskites, aluminates, titanates, zirconates. It will also be possible to use clays, particularly those of the families of the kaolinites, smectites, or illites. Zeolites or mixtures of zeolites will also be able to make possible the optimization of the properties of the material.

Among the peptizing agents, it is possible to cite the organic or inorganic bases or acids, such as acetic acid, hydrochloric acid, sulfuric acid, formic acid, citric acid and nitric acid, by itself or in a mixture, soda, potash, ammonia, or alternatively an amine, a quaternary ammonium compound, selected from, for example, the alkyl ethanolamines or the ethoxylated alkyl amines, the tetraethylammonium hydroxide or else tetramethylammonium hydroxide.

The various additives will be able to be used by themselves or in a mixture, introduced together or in a sequenced manner.

### Shaping Step c)

According to the invention, the paste obtained at the end of the final mixing or additivation step performed is shaped.

The shaping is performed by passage through a die. This die can be a flat die that makes it possible to obtain films, or a ring die that makes it possible to obtain a ring whose cross-section corresponds to the shape of said die. They can thus have, for example, a cylindrical shape that may or may not be hollow, multi-lobed (having 2, 3, 4 or 5 lobes, for example), grooved, slotted, twisted. A shearing leaving the die makes it possible to produce extrudates of specified length. It is not ruled out that said obtained materials are then, for example, introduced into a piece of equipment that makes it possible to smooth their surface, such as a profile template or any other piece of equipment making possible their spheronization. In a particular arrangement, the porous inorganic product is obtained in the form of powder and of agglomerates in the case of an extrusion without using a die.

All of the steps a) to c), and b1), b2), b3) when they are carried out, are performed within an extruder. Said extruder has at least one screw that is able to turn inside a fixed casing called an extruder barrel, at the end of which a die is positioned that imposes its shape on the extruded product. Although the method according to the invention can be carried out in a single-screw extruder, it is preferred to direct it in a co-rotating or counter-rotating twin-screw extruder, because of its highly flexible nature.

The entire method is thermostated from the main feeding means to the extrusion die. The extruder is made up of successive modules that are arranged coaxially and that have independent and adjustable heating zones, which makes it possible to apply the exact temperature desired for the material during mixing/extrusion as a function of its positioning in the method. The temperature range used varies from 15 to 600° C., preferably from 15 to 350° C., in an even more preferred way from 20 to 300° C., and in a very preferred manner from 30 to 150° C. The screws and the extruder barrels are made by the assembly of modules in sequence whose arrangement and sequence can be altered. It will thus be possible to associate conveyance elements having a more or less wide pitch, mixing blocks, retro-mixing blocks, turbines, etc. (Procédés d'extrusion reactive [Reactive Extrusion Methods], F. BERZIN, G.-H. H U, A M 3654, Techniques de I'Ingénieur [Engineering Techniques], 2004, Paris).

The longitudinal geometry of the twin-screw extruder makes it possible to link together, along the former, unit operations such as the feeding, the conveyance and evaporation of solvents, the mixing of the reagents, the reaction, the devolatilization, the pumping, and the shaping. Moreover, the introduction of other elements, such as washing solvents, for example, can be performed via secondary feeding zones positioned downstream from the main feed hopper. Consequently, draw-off zones are present for the removal of any excess liquids. Finally, such a tool can also operate under an inert atmosphere via the scavenging of a suitable vector gas (N₂, Ar), thus making possible the use of precursors that decompose in the presence of water or air.

Likewise, adaptable mixing modules that constitute each of the two rotating screws used make it possible to apply customized mixing conditions as a function of the location of the material in the extruder barrel, as well as the length of the mixing zone before extrusion. The operating conditions of the extrusion, such as the screw profile, the dwell time of the material, the screw rotation speed will be set by the person skilled in the art as a function of the desired final characteristics.

The extruder used for carrying out the method according to the invention advantageously has a ratio L/D (length to diameter) of between 1 and 200, in a preferred manner between 2 and 120, advantageously between 20 and 100, and in a very preferred manner between 30 and 100. The reactive extrusion can be performed advantageously with the following conditions:
a single-screw-or twin-screw-type screw profile, advantageously twin-screw, co-rotating or counter-rotating,
an average dwell time of the mixture in the extruder, i.e., the average time to perform all of the steps from a) to c), and therefore including optionally steps b1), b2) and b3), between 0.1 minute and 120 minutes, preferably between 0.1 and 60 minutes, in a preferred manner less than 30 minutes, and in a very preferred manner less than 10minutes,
a rotation speed of the screws of between 5 and 1500 revolutions per minute, preferably between 5 and 500 revolutions per minute, and in a preferred manner between 25 and 200 rpm.

Thus, the modules will be selected by a person skilled in the art in such a way as to make it possible to perform the steps of the preparation method according to the invention.

Heat Treatment and/or Hydrothermal Treatment Step d)

The shaped material obtained at the end of step c) can optionally undergo one or more heat treatment steps.

Thus, the shaped material obtained at the end of step c) can optionally undergo a drying step, which can be performed by all of the techniques known to a person skilled in the art. In particular, it is performed by passing through an oven at a temperature of between 50 and 150° C. In the particular case of obtaining a porous inorganic material comprising reduced or sulfurized metal particles or any other particles sensitive to the air at the end of step c) of the preparation method according to the invention, said drying step will be performed under an inert atmosphere.

As is known to a person skilled in the art, an autoclaving step can be carried out in the case where it is desired to accomplish the crystallization of the shaped porous inorganic material obtained at the end of step c).

This autoclaving step, which is a specific hydrothermal treatment, consists in placing said shaped material in a closed chamber in the presence of a solvent at a given temperature so as to work under an inherent self-generating pressure under the selected operating conditions. The solvent used is advantageously a protic polar solvent. Preferably, the solvent used is water. The volume of solvent introduced is defined in relation to the volume of the selected autoclave, the mass introduced, and the treatment temperature. Thus, the volume of solvent introduced is in a range from 0.01 to 20% relative to the selected autoclave volume, preferably in a range from 0.05 to 5%, and in a more preferred way in a range from 0.05 to 1%. The autoclaving temperature is between 50 and 200° C., preferably between 60 and 170° C., and in an even more preferred manner between 60 and 120° C. This treatment makes it possible, if necessary as a function of the final properties desired for the porous inorganic material, to achieve the growth of zeolitic entities in the walls of the oxide-based matrix. The autoclaving is maintained over a period of 1 to 96 hours and preferably over a period of 10 to 72 hours. The drying of the particles after autoclaving is advantageously performed by placement in the oven at a temperature of between 50 and 130° C.

The shaped material obtained at the end of step c) can also optionally undergo a calcination step in air in a temperature range from 130 to 1000° C. and more precisely in a range from 300 to 600° C. for a period of 1 to 24 hours and in a preferred way for a period of 2 to 12 hours.

The shaped material at the end of step c) can also optionally undergo a steaming-type hydrothermal treatment in a furnace in the presence of water vapor. The temperature during the steaming can be between 300 and 1100° C. and preferably higher than 700° C. for a period of time of between 30 minutes and 12 hours, preferably between 30 minutes and 4 hours. The content of water vapor is greater than 20 g of water per kg of dry air and preferably greater than 40 g of water per kg of dry air and in a preferred manner greater than 100 g of water per kg of dry air. Such a treatment can, if necessary, replace the calcination treatment completely or partially.

### Techniques of Characterization

The material used according to the invention is characterized by several techniques of analyses as a function of its final properties and particularly by: low-angle X-ray diffraction (low angle XRD), high-angle X-ray diffraction (XRD), nitrogen volumetric analysis (BET). As a function of their nature, the presence of the metal particles as described in this description can be demonstrated by different techniques, in particular by the following spectroscopies: Raman, UV-visible or even infrared. Techniques such as nuclear magnetic resonance (NMR) or even electron paramagnetic resonance (EPR) can also be used depending on the precursors used.

The techniques described for characterizing the oxide metal particles also make it possible to characterize the precursors of said oxide metal particles.

The low-angle (values of the angle 2q between 0.5 and 5°) X-ray diffraction technique makes it possible to characterize the periodicity on the nanometric scale generated by the organized mesoporosity of the oxide-based matrix when the former is referred to as mesostructured. In the following disclosure, the analysis of the X-rays is done on powder with a diffractometer that operates by reflection and that is equipped with a rear monochromator by using the radiation of copper (wavelength of 1.5406 Å). The peaks that are usually observed on the diffractograms corresponding to a given value of the angle 2q are combined with interreticular distances d(hkl) that are characteristic of the structural symmetry of the material ((hkl) being the Miller indices of the reciprocal network) by Bragg's equation:2 d*sin(q)=n*λ. This indexing then makes it possible to determine mesh parameters (abc) of the direct network, the value of these parameters being a function of the hexagonal, cubic or vermicular structure that is obtained.

The high-angle (values of the angle 2q of between 6 and 100°) X-ray diffraction technique makes it possible to characterize a crystallized solid that is defined by the repetition of an individual pattern or an elementary mesh on the molecular scale. It follows the same physical principle as the one that governs the low-angle X-ray diffraction technique. The high-angle XRD technique is therefore used to analyze the materials used according to the invention because it is very particularly suited to the structural characterization of the metal particles that can be crystallized and nanocrystals of zeolites optionally trapped in the walls of the oxide-based matrix, as well as to the structural characterization of the zeolitic entities that optionally constitute said walls.

The nitrogen volumetric analysis that corresponds to the physical adsorption of nitrogen molecules in the porosity of the inorganic material obtained according to the invention via a gradual increase in the pressure at constant temperature provides information about the particular textural characteristics (diameter of pores, pore volume, specific surface area) of the material used according to the invention. In particular, it makes it possible to access the specific surface area and the mesopore distribution of the material. Specific surface area is defined as the BET specific surface area (SBET in m2/g) determined by nitrogen adsorption according to the standard ASTM D 3663-78 established from the BRUNAUER-EMMETT-TELLER method described in the periodical “The Journal of American Society,” 1938, 60, 309. The pore distribution that is representative of a population of mesopores centered in a range from 2 to 50 nm (IUPAC classification) is determined by the Barrett-Joyner-Halenda (BJH). The nitrogen adsorption-desorption isotherm according to the BJH model thus obtained is described in the periodical “The Journal of American Society,” 1951, 73, 373, written by E. P. Barrett, L. G. Joyner and P. P. Halenda. In the following disclosure, the diameter of the mesopores f of the oxide-based matrix corresponds to the value of the maximum diameter read on the pore size distribution curve obtained from the adsorption branch of the nitrogen isotherm. Moreover, the form of the nitrogen adsorption isotherm and the hysteresis loop can provide information on the nature of the mesoporosity and on the presence of the optional microporosity of the inorganic material obtained according to the invention. The quantitative analysis of the microporosity of the inorganic material obtained according to the invention is performed from the following methods: “t” (method of Lippens-De Boer, 1965) or “αs” (method proposed by Sing) that correspond to transforms of the starting adsorption isotherm as described in the work “Adsorption by Powders and Porous Solids. Principles, Methodology and Applications” written by F. Rouquerol, J. Rouquerol and K. Sing, Academic Press, 1999. These methods make it possible to access in particular the value of the micropore volume that is characteristic of the microporosity of the inorganic material obtained according to the invention.

### EXAMPLES

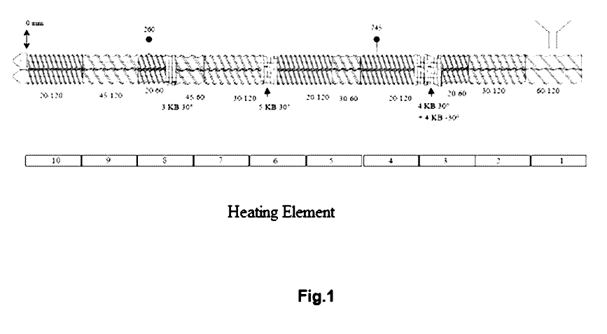

In the examples that follow, a co-rotating twin-screw extruder LSM 30-34 (Leistritz brand with L/D=34 and D=34 mm) is used. The extruder barrel is divided into 10 zones (called modules) that can be individually parameterized in temperature, from 20 to 110° C. The screw profile used is shown in FIG. 1. It is without reverse pitch.

### Example 1

### (For Comparison)—Synthesis in Batch Mode

The precursors, a basic aluminum salt [AlOONa] and an acid aluminum salt [Al₂(SO₄)₃], are fed continuously for 30 minutes into a 5-liter reactor, at a temperature of 60° C. in which the precipitation takes place. The ratio of the acid/solid flow rates is adjusted so that the pH is equal to 9. The goal is to produce a final concentration of alumina of 45 g/l.

The suspension obtained is then filtered by displacement of water over a sintered Buchner-type tool, and the alumina gel obtained is washed 3 times with 5 l of distilled water. The fire loss of the powder at the end of this step is about 90%.

The alumina gel is dried at 120° C. in an oven for one night. The fire loss of the powder at the end of this step is about 23%.

The dried gel forms a powder that is introduced into a Brabender-type mixer. A nitric acid aqueous solution with a total acid level of 3%, expressed by weight relative to the mass of the dried gel introduced into the mixer, is added in 10 minutes, during a mixing at 20 revolutions/minute (fire loss of 62%). The acid mixing is continued for 5 minutes. A neutralization step is then performed by adding an ammoniacal solution into the mixer (fire loss of 61%). The mixing is continued for 3 minutes.

The paste obtained is then extruded through a tri-lobed 2-mm die. The extrudates obtained are dried at 100° C. for one night, and then calcined for 2 hours at 500° C. under a flow of moist air in a tubular furnace.

Obtaining the porous inorganic material therefore necessitates numerous manipulations. Further, more than 24 hours pass between the introduction of the precursors and the obtaining of the extrudate.

### Example 2

### (Compliant)—Production of a Porous Inorganic Material from a Mixture of Two Liquid Precursors Without a Premixture

Two aluminum precursors in solution in water, aluminum nitrate Al₂(NO₃)₃ and sodium aluminate AlO₂Na previously preheated to 60° C., are fed into the first module via the main feed hopper of the extruder, which is operated with a mixing speed of 50 rpm. This first module makes it possible to perform the reaction step a), during which the nucleation, growth, aggregation and agglomeration reactions take place.

The precursors in solution are introduced using two peristaltic pumps. The sum of the flow rates is equal to 3 l/hour, and the ratio of the quantity of basic aluminum precursor to the quantity of aluminum acid precursor is adjusted so as to make it possible to set the pH at 9. At the exit of module 1, i.e., at the end of step a), the fire loss is more than 80%.

The following modules are organized in a sequence of conveying elements and mixing elements. The beginning of the extruder (modules 2 to 5) is used as a zone for conveying and for drying the paste in which step b) is carried out. The temperature of modules 2 to 5 is set at 110° C. At the end of module 5, the fire loss of the paste is 60%, the fire loss being calculated by the difference in mass before and after calcination at 1000° C.

Additivation step b3) is carried out in modules 6 to 10. These modules are set at a temperature of 20° C. At the inlet of module 6, a solution of nitric acid (4% by weight of acid relative to Al₂O₃) and of methocel™ (1% by weight of mass relative to the dry mass) is injected. At the inlet of module 10, an ammoniacal solution is added (40% by weight relative to the amount of acid introduced). The paste obtained at the end of module 10 is then extruded via a tri-lobed ring die 3 so as to obtain rings with a diameter of 3 mm. The former are then dried for 12 hours in the oven at 80° C., and then calcined in air for 2 hours at 550° C.

The solid is characterized by XRD and by nitrogen volumetric analysis. The nitrogen volumetric analysis combined with the BET method leads to a value of the mesopore volume Vₘₑₛₒ (N₂) of 0.71 ml/g and a specific surface area of the final material of S=250 m²/g. The mesopore diameter, obtained by the BJH method, is 7.4 nm. The XRD analysis makes it possible to identify the gamma-alumina phase.

### Example 3

### (Compliant)—Production of a Material from a Mixture of Two Liquid Precursors with a Premixer

This example differs from Example 2 only in that a Y premixer is placed upstream from the feed hopper so as to control the growth [and] nucleation steps of the co-precipitation. The aggregation and agglomeration steps then take place in module 1.

The solid is characterized by XRD and by nitrogen volumetric analysis. The nitrogen volumetric analysis combined with the BET method leads to a value of the mesopore volume Vₘₑₛₒ(N₂) of 0.60 ml/g and a specific surface area of the final material of S=240 m²/g. The mesopore diameter, obtained by the BJH method, is 7.8 nm. The XRD analysis makes it possible to identify the gamma-alumina phase.

### Example 4

### (Compliant)—Example 3+ Phosphorus Co-Mixing

This example differs from Example 3 only in that at the inlet of module 7, an injection of a solution containing phosphoric acid corresponding to 1% by weight of P₂O₅ relative to Al₂O₃ is initiated in addition.

The solid is characterized by XRD and by nitrogen volumetric analysis. The nitrogen volumetric analysis combined with the BET method leads to a value of the mesopore volume Vₘₑₛₒ(N₂) of 0.59 ml/g and a specific surface area of the final material of S=290 m²/g. The mesopore diameter, obtained by the BJH method, is 5.1 nm. The XRD analysis makes it possible to identify the gamma-alumina phase.

### Example 5

### Example 3+ Silicic Acid Co-mixing

This example differs from Example 3 only in that at the inlet of module 7, an injection of a solution containing silicic acid corresponding to 1% by weight of SiO₂ relative to Al₂O₃ is initiated in addition.

The solid is characterized by XRD and by nitrogen volumetric analysis. The nitrogen volumetric analysis combined with the BET method leads to a value of the mesopore volume Vₘₑₛₒ(N₂) of 0.61 ml/g and a specific surface area of the final material of S=290 m²/g. The mesopore diameter, obtained by the BJH method, is 6.1 nm. The XRD analysis makes it possible to identify the gamma-alumina phase.

### Example 6

### Production of a Material from a Mixture of a Precursor in Solution and of a Solid Precursor (Boehmite)

A viscous solution, or colloidal suspension, containing 10% by weight of a boehmite Pural™and 3% by weight of nitric acid relative to Al₂O₃, is fed into the main hopper at the inlet of module 1. Simultaneously, a silica sol is introduced so as to obtain a final porous inorganic material containing 30% by weight of SiO₂ relative to the sum Si0₂+Al₂O₃. Module 1 is set at a temperature of 60° C. The extruder is operated with a screw rotation speed of 50 rpm. The reaction leading to the aluminosilicate takes place in module 1.

The following modules are organized in a sequence of conveying elements and mixing elements. The beginning of the extruder (modules 2 to 5) is used as a zone for conveying and for drying the paste in which step b) is carried out. The temperature of modules 2 to 5 is set at 110° C. At the end of module 5, the fire loss of the paste is 70%, the fire loss being calculated by the difference in mass before and after calcination at 1000° C.

Modules 6 to 10 are set to a temperature of 20° C. The paste obtained at the end of module 10 is then extruded via a tri-lobed ring die 3 so as to obtain rings with a diameter of 3 mm. The former are then dried for 12 hours in the oven at 80° C., and then calcined in air for 2 hours at 550° C.

The solid is characterized by XRD and by nitrogen volumetric analysis. The nitrogen volumetric analysis combined with the BET method leads to a value of the mesopore volume Vₘₑₛₒ(N₂) of 0.35 ml/g and a specific surface area of the final material of S=450 m²/g. The mesopore diameter, obtained by the BJH method, is 4.1 nm. The XRD detects the rays of the5 gamma-alumina and the presence of amorphous material (amorphous silica).

Obtaining the porous inorganic material for Examples 2 to 6 according to the invention is performed continuously in a single tool. Only a few minutes pass between the introduction of the precursors and obtaining the extrudate.

1. Method for preparing a porous inorganic material having at least the following steps:
a) Nucleation, growth, agglomeration and aggregation reactions of precursors of a mixture comprising at least one precursor of the oxide of a metal X in solution in a solvent and a precursor of the oxide of a metal Y at a temperature of between 30 and 70° C., X and Y being, independently, selected from the group consisting of aluminum, cobalt, indium, molybdenum, nickel, silicon, titanium, zirconium, zinc, iron, copper, manganese, gallium, germanium, phosphorus, boron, vanadium, tin, lead, hafnium, niobium, yttrium, cerium, gadolinium, tantalum, tungsten, antimony, europium and neodymium;
b) mixing of the mixture obtained at the end of step a) at a temperature of between 80 and 150° C., the mixing period being adjusted so as to obtain a paste that exhibits a fire loss of between 20% by weight and 90% by weight at the end of this step;
c) shaping of the porous inorganic material;
steps a) to c) being performed within an extruder.

2. Method according to claim 1, in which said solvent is water, ethanol, propan-1-ol, propan-2-ol, 2-methylpropan-1-ol, 2-methyl-propan-2-ol, 2,2-dimethylpropanol, butanol, 2-butanol, 2-methylbutan-2-ol, 3-methylbutan-2-ol, pentanol, 2-methylbutan-1-ol, 3-methylbutan-1-ol, pentan-2-ol, pentan-3-ol, by itself or in a mixture.

3. Method according to one of claim 1, in which the mixture reacting in step a) comprises at least one basic precursor selected from among sodium aluminate, potassium aluminate, ammonia, sodium hydroxide and potassium hydroxide, and at least one acid precursor selected from among aluminum sulfate, aluminum chloride, aluminum nitrate, sulfuric acid, hydrochloric acid and nitric acid, at least one of the basic or acid precursors comprising aluminum, the relative flow rate of the acid and basic precursors being selected so as to obtain a pH of the reaction medium of between 7 and 10.5.

4. Method according to claim 1, in which the mixture reacting during step a) does not contain any surfactant that generates mesoporosity.

5. Method according to claim 1, in which, following step b) and prior to step c), the following steps are initiated:
b1) washing of the undesirable radicals in the final porous inorganic material;
b2) heating of the mixture obtained at the end of step b1) to a temperature of between 80 and 150° C., the heating period being adjusted so as to obtain a paste having a fire loss of between 20% and 90% by weight at the end of this step;
steps b1) and b2) being performed within the extruder.

6. Method according to claim 1, in which, prior to step c), the following step is initiated:
b3) mixing and additivation of the paste obtained at the end of step b), said additivation consisting in the addition of one or more solid or liquid additives, formulation additives, peptizing agents, by themselves or in a mixture, during the mixing;
step b3) being performed within the extruder.

7. Method according to claim 5, in which, prior to step c), the following step is initiated:
b3) mixing and additivation of the paste obtained at the end of step b2), said additivation consisting in the addition of one or more solid or liquid additives, formulation additives, peptizing agents, by themselves or in a mixture, during the mixing;
step b3) being performed within the extruder.

8. Method according to claim 5, in which the fire loss at the end of step b2) is between 20% by weight and 75% by weight.

9. Method according to claim 1, in which a step d) is initiated for heat treatment and/or hydrothermal treatment of the shaped porous inorganic material obtained at the end of step c).

10. Method according to claim 1, in which the average dwell time for performing the steps from a) to c) is between 0.1 and 120 minutes.

11. Method according to claims 1 , in which the fire loss at the end of step b) is between 20% by weight and 75% by weight.

12. Method according to claim 1, in which the steps a) to c) are performed within a twin-screw extruder.
